(19) United States
(12) Patent Application Publication
(10) Pub. No.: US 2011/0229149 A1
(43) Pub. Date: Sep. 22, 2011

(54) OPTICAL TRANSMITTER SUPPLYING OPTICAL SIGNALS HAVING MULTIPLE MODULATION FORMATS

(75) Inventors: STEPHEN G. GRUBB, Reisterstown, MD (US); David F. Welch, Atherton, CA (US)

(73) Assignee: Infinera Corporation

(21) Appl. No.: 12/728,951

(22) Filed: Mar. 22, 2010

(51) Int. Cl. H04B 10/04

(52) U.S. Cl. 398/188

(57) ABSTRACT

Consistent with the present disclosure, a compact transmitter is provided that can generate optical signals having different modulation formats depending on optical link requirements. Preferably, the transmitter includes a photonic integrated circuit having multiple lasers and modulators. A control circuit adjusts the drive signals supplied to the modulators such that optical signals having a desired modulation format may be output from the modulators. Thus, for example, the transmitter may be used to output optical signals having a modulation format suitable for long haul or submarine links, as well as for links having a shorter distance. Moreover, the same photonic integrated circuit may supply optical signals with different modulation formats, such that, for example, those optical signals that are dropped along a link, and thus travel a shorter distance, may have a first modulation format, while other optical signals that travel the entire length of the link may have a second modulation format that is more suited for longer distances.

### BACKGROUND

Wavelength division multiplexed (WDM) optical communication systems are known in which multiple optical signals or channels, each having a different wavelength, are combined onto an optical fiber. Such systems typically include a laser associated with each wavelength, a modulator configured to modulate the optical signal output from the laser, and an optical combiner to combine each of the modulated optical signals.

Typically, the optical signals are modulated in accordance with a modulation format. Various modulation formats are known, such as on-off-keying (OOK), differential phase shift keying (DPSK), differential quadrature phase shift keying (DQPSK), quadrature phase shift keying (QPSK), and binary phase shift keying (BPSK). As generally understood, different modulation formats may have different optical characteristics. For example, certain modulation formats may be more sensitive to noise, and thus may be associated with a higher bit error rate if noise is present on a given optical link. In addition, some modulation formats may have a higher spectral density and thus can carry more data per unit of spectrum than others. Still, others may have a higher tolerance for chromatic dispersion (CD) and polarization mode dispersion (PMD) and may require little or no CD or PMD compensation for a given amount of CD or PMD.

In general, those modulation formats that have a higher spectral density, such that more information or bits are carried per unit of spectrum, will typically have less energy per bit. As a result, high spectral density modulation formats are more susceptible to transmission non-idealities, and thus will have higher bit error rates for a given amount of PMD or optical signal noise, for example. Accordingly, such modulation formats may be used to carry data at relatively higher rates over shorter distances. On the other hand, those modulation formats that require more energy per bit have will have lower bit error rates, but are spectrally less efficient. Such lower spectral density modulation formats, therefore, may be used to carry data over longer distances.

Conventional WDM systems typically include a series of printed circuit boards or cards, such that each one supplies or outputs a corresponding optical channel. Such cards typically include discrete components, such as a laser, modulator, and modulator driver circuit, which are associated with each channel. Typically, different cards are provided for different optical links, such that optical signals having an appropriate modulation format are supplied to a given link. For example, specific cards may be provided to supply signals that are transmitted over long distance links, such as those which may be used in undersea or submarine systems, while other cards may be provided to supply signals to shorter distance terrestrial links. Thus, cards are often tailored for different optical links. As a result, the costs for manufacturing each card may be excessive and there may be no flexibility to trade off capacity and reach when deploying in various network links

### SUMMARY OF THE INVENTION

Consistent with the present disclosure, a transmitter is provided that includes a control circuit configured to selectively supply one of first control signals and one of second control signals. A driver circuit is also provided that is coupled to the control circuit and is configured to output a first plurality of drive signals in response to the first control signals and a second plurality of drive signals in response to the second control signals. In addition, a substrate is provided and a plurality of modulators is provided on the substrate. Each of the plurality of modulators is coupled to the driver circuit, and each of the plurality of modulators is configured to supply a corresponding one of a plurality of modulated optical signals, such that, in response to the first plurality of drive signals, the modulated optical signals have a first modulation format, and, in response to the second plurality of drive signals, the modulated optical signals have a second modulation format different than the first modulation format.

Consistent with an additional aspect of the present disclosure, a transmitter is provided that includes a control circuit coupled to the driver circuit. The control circuit is configured to selectively supply first, second, third, and fourth control signals. In addition, a driver circuit is provided that is configured to output first, second, third, and fourth pluralities of drive signals in response to the first, second, third, and fourth control signals, respectively. Moreover a substrate is provided and a plurality of optical outputs is provided on the substrate. Wherein, first ones of the plurality of optical outputs supply first light having a first polarization in response to the first plurality of drive signals, and second ones of the plurality of optical outputs are deactivated in response to the second plurality of drive signals. In addition, the first ones of the plurality of optical outputs are deactivated in response to the third plurality of drive signals, and the second ones of the plurality of optical outputs supply second light having a second polarization in response to the fourth plurality of drive signals.

It is to be understood that both the foregoing general description and the following detailed description are exemplary and explanatory only and are not restrictive of the invention, as claimed.

The accompanying drawings, which are incorporated in and constitute a part of this specification, illustrate embodiments and together with the description, serve to explain the principles of the disclosure.

### BRIEF DESCRIPTION OF THE DRAWINGS

FIG. 1 illustrates an optical communication system consistent with an aspect of the present disclosure;

FIG. 2 illustrates a transmitter photonic integrated circuit and associated circuitry consistent with an additional aspect of the present disclosure;

FIGS. 3a-3c shows a portion of the transmitter photonic integrated circuit shown in FIG. 2 in different operation modes consistent with an aspect of the present disclosure; and

FIGS. 4a-4c illustrates examples of constellations of modulated optical signals generated in accordance with an additional aspect of the present disclosure; and

FIG. 5 illustrates an additional example of an optical communication system consistent with a further aspect of the present disclosure.

### DESCRIPTION OF THE EMBODIMENTS

Consistent with the present disclosure, a compact multichannel transmitter is provided that can generate optical signals having different modulation formats depending on optical link requirements. Preferably, the transmitter includes a photonic integrated circuit having multiple lasers and modulators. A control circuit adjusts the drive signals supplied to the modulators such that optical signals having a desired modulation format may be output from the modulators. Thus, for example, the transmitter may be used to output optical signals having a modulation format suitable for long haul or submarine links, as well as for links having a shorter distance. Moreover, the same photonic integrated circuit may supply optical signals with different modulation formats, such that, for example, those optical signals that are dropped along a link, and thus travel a shorter distance, may have a first modulation format, while other optical signals that travel the entire length of the link may have a second modulation format that is more suited for longer distances. Accordingly, instead of designing and manufacturing different transmitters, the same transmitter, for example, may be used to output optical signals for transmission on a variety of different links.

Reference will now be made in detail to the present exemplary embodiments, examples of which are illustrated in the accompanying drawings. Wherever possible, the same reference numbers will be used throughout the drawings to refer to the same or like parts.

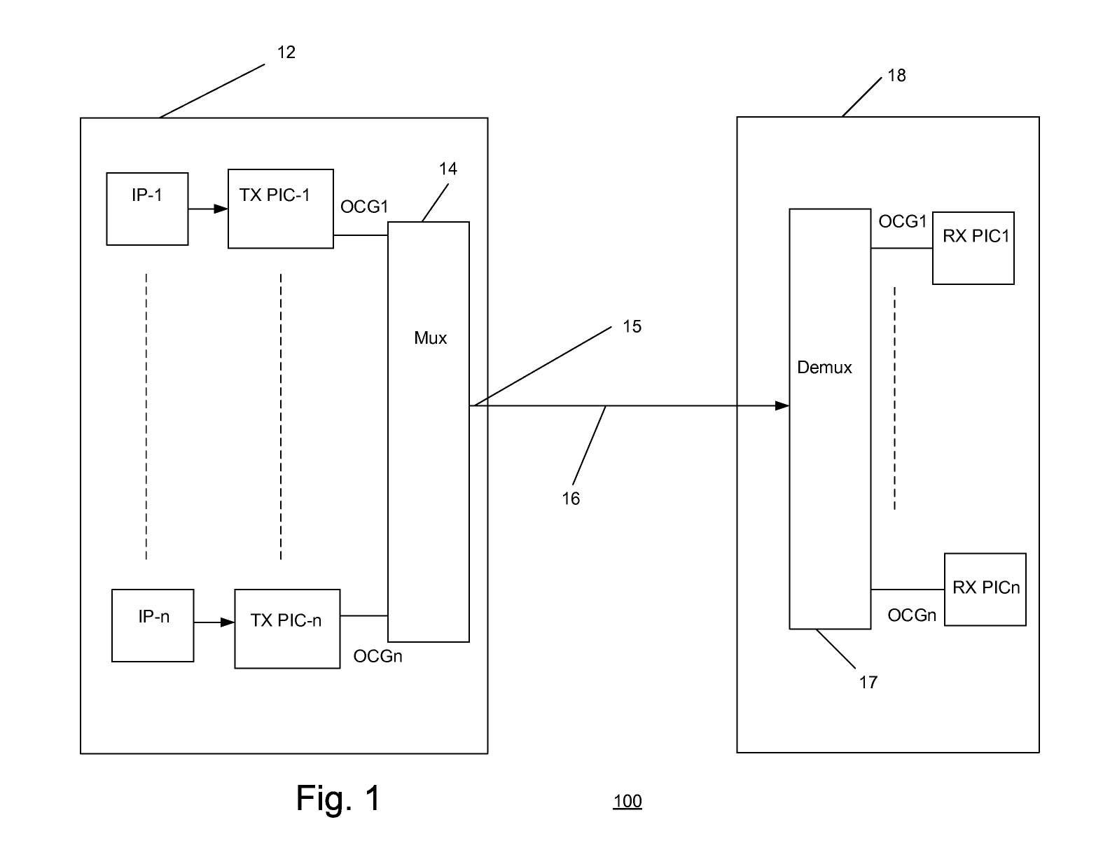

FIG. 1 illustrates an optical communication system 100 consistent with an aspect of the present disclosure. System 100 includes, for example, a transmit node 12 that has a plurality of photonic integrated circuits TX PIC-1 to TX PIC-n. Each of TX PIC-1 to TX PIC-n receives data from a corresponding one of input blocks IP-1 to IP-n and supplies the data, in encoded form, on a corresponding one of optical carrier groups OCG1 to OCGn to multiplexer 14. Each optical carrier group include a group of optical signals, each of which having a corresponding one of a plurality of wavelengths. Typically the wavelengths of optical signals in each optical carrier group are spectrally spaced from one another by a relatively wide wavelength spacing, such as 200 GHz. Multiplexer 14 may include a known optical interleaver that combines the optical carrier groups in an interleaving fashion. For example, multiplexer 14 may combine OCGs with 200 GHz spacing and interleave them, to create a spectrally denser wavelength division multiplexed (WDM) signal with channels or optical signals spaced 50 GHz apart. Such interleaving may be repeated to generate spectrally denser WDM signals having 25 GHz or 12.5 GHz spacings.

As further shown in FIG. 1, the combined OCGs are supplied to an output waveguide 15, which, in turn, feeds the OCGs to optical path or fiber 16. A receiver 18 is configured to receive the OCGs, and a demultiplexer 17, including a known deinterleaver, may separate the OCGs, and supply each to a corresponding one of receiver PICs RX PIC-1 to RX PIC-n (collectively, RX PICs). The RX PICs converts each optical signal within each optical carrier group (OCG) into corresponding electrical signals, which are then further processed by additional circuitry (not shown). Examples of TX PICs and RX PICs are described in U.S. Patent Publication No. 20090245795 and application Ser. No. 12/572,179 the entire contents of both of which are incorporated herein by reference.

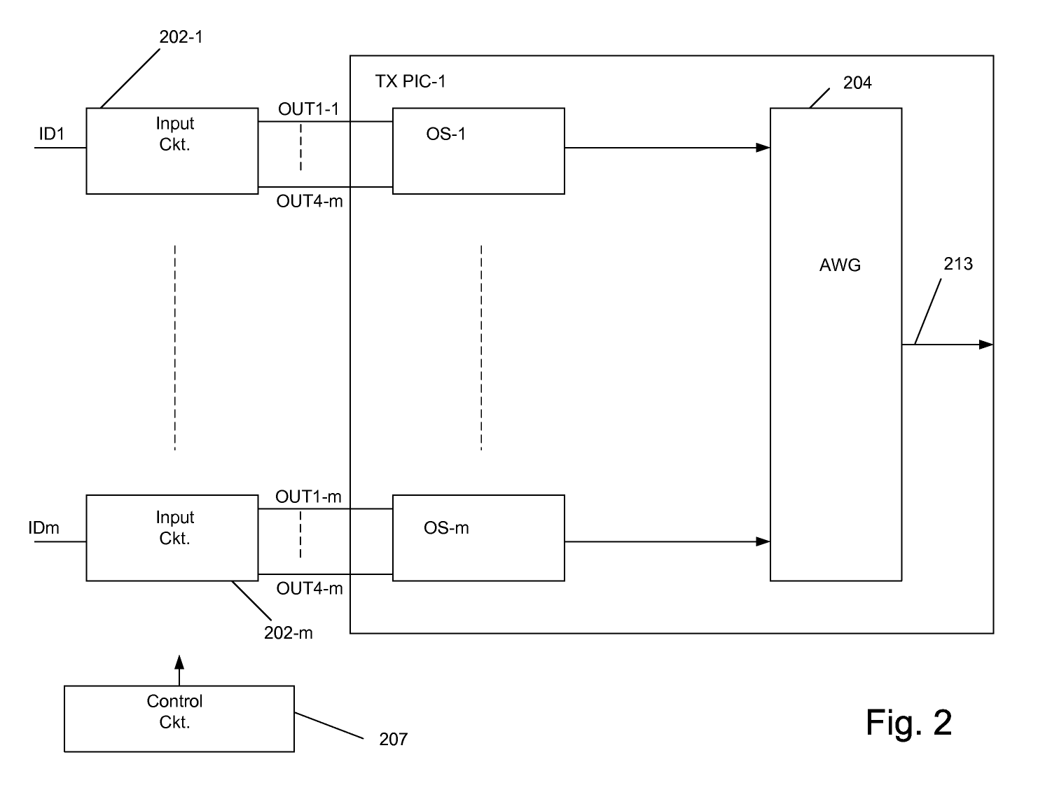

FIG. 2 illustrates TX PIC-1 and associated circuitry in greater detail. It is understood that remaining TX PICs (e.g., TX PIC-2 to TX PIC-m) have the same or similar structure as TX PIC-1. TX PIC-1 includes optical sources OS-1 to OS-m coupled to corresponding ones of input circuits 202-1 to 201-m, which may be included in input block IP-1, for example. Input circuits 202-1 to 202-m receive a corresponding one of input data streams ID1 to IDm, which are subject to known processing, such as FEC encoding among other processing, and output on one or more of outputs (e.g., outputs OUT1-1 to OUT4-1 of input circuit 202-1 and outputs OUT1-m to OUT4-m of input circuit 202-m) to a respective one of optical sources OS-1 to OS-m. Each of optical sources OS-1 to OS-m supplies a corresponding one of a plurality of modulated optical signal to a multiplexer, such as a known arrayed waveguide grating (AWG) 204. AWG 204, in turn, may be configured to multiplex or combine each of the plurality of optical signals onto output waveguide 213. As discussed in greater detail below, control circuit 207 regulates the output of encoded data from input circuits 202-1 tO 202-m.

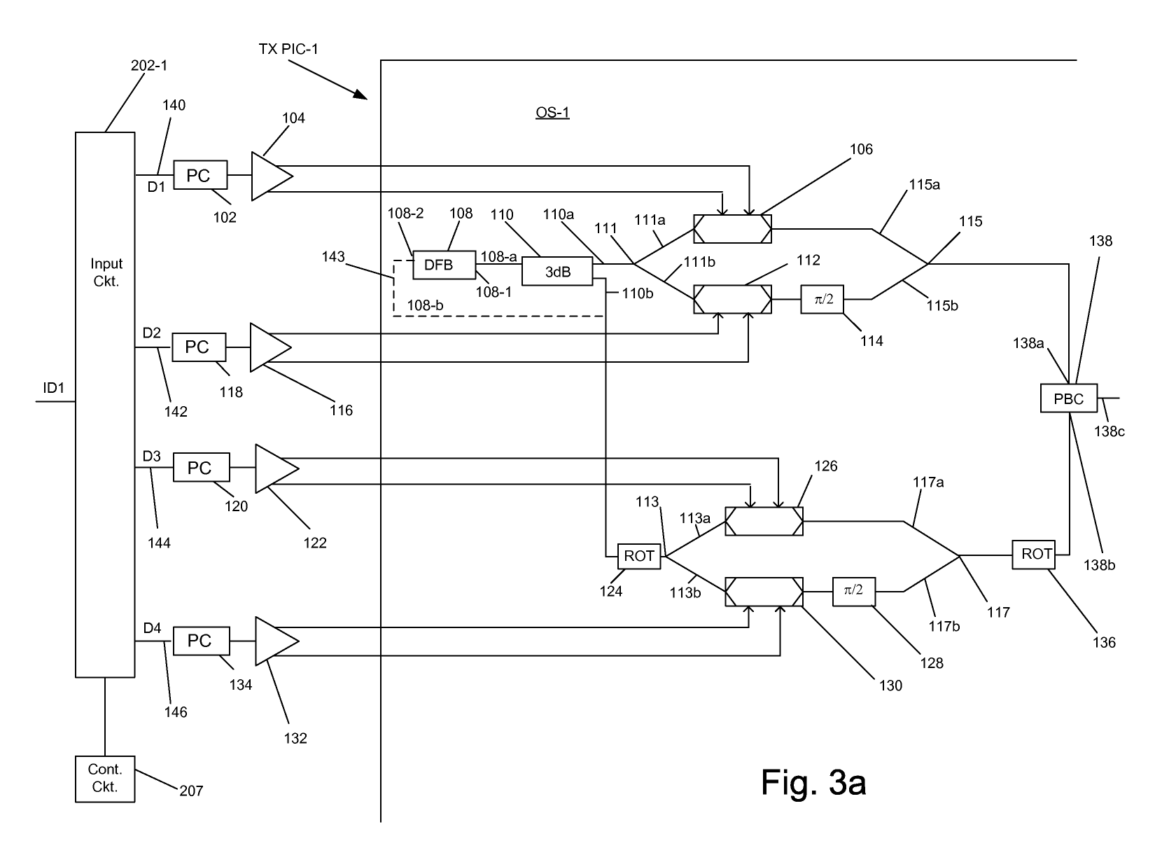

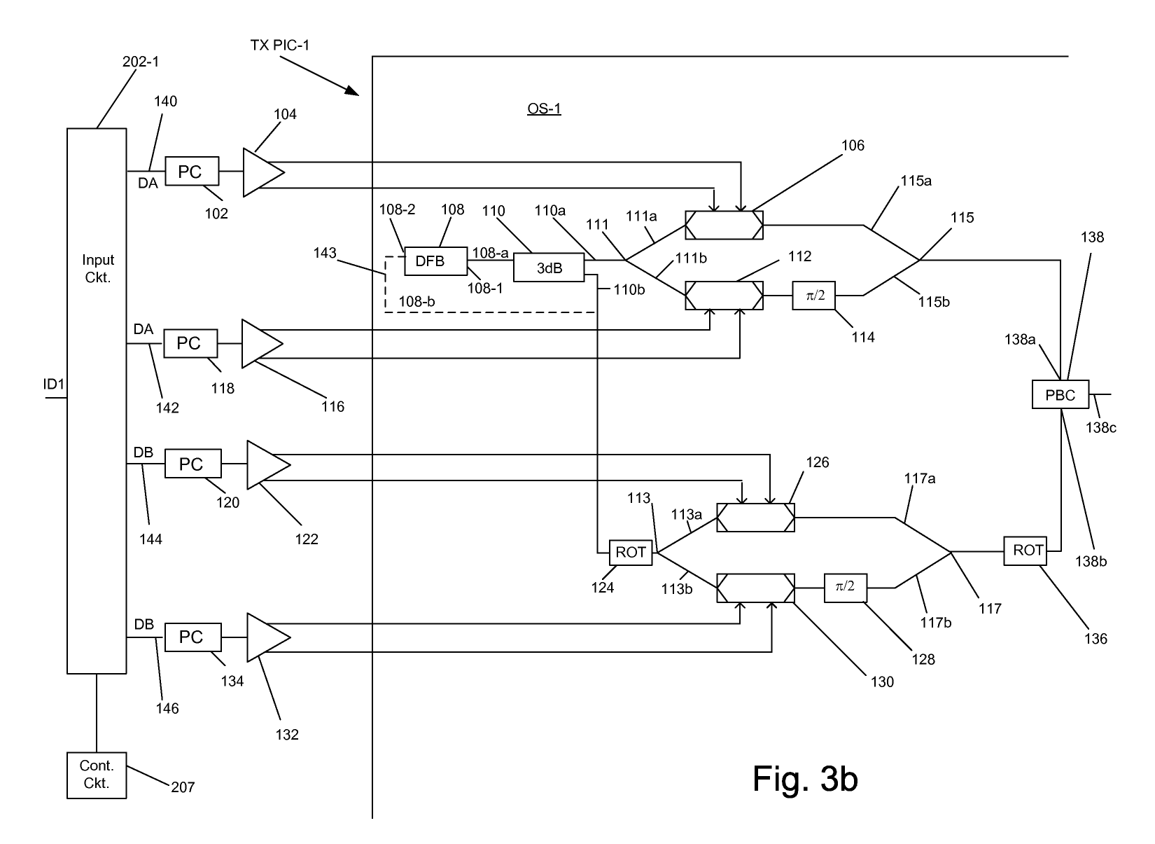

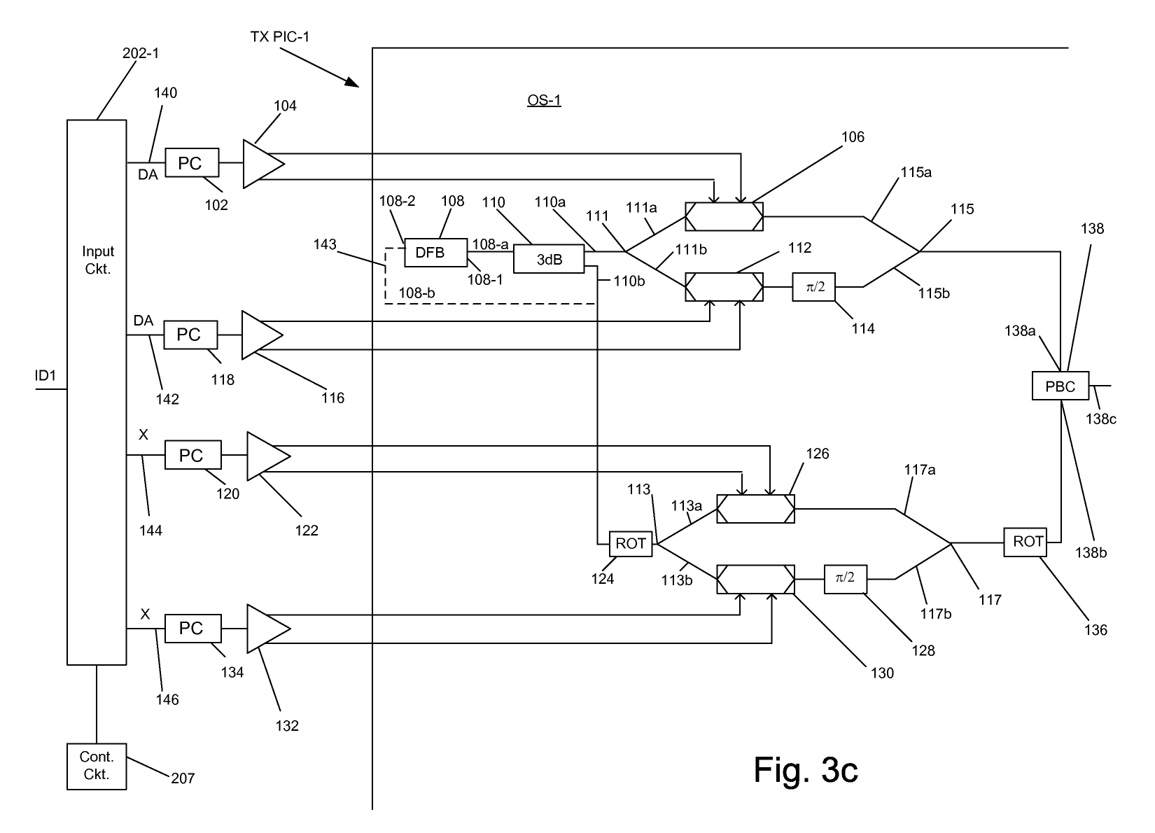

FIG. 3a shows optical source OS-1 in greater detail. It is understood that remaining optical sources OS-1 to OS-m have the same or similar structure as optical source OS-1. As discussed in greater detail below, FIG. 3a illustrates optical source OS-1 operating in a first mode in which a polarization multiplexed differential quadrature phase shift keying (DQPSK) modulated optical signal at a given wavelength is output form OS-1. Namely, control circuit 207 supplies first control signals such that input circuit 202-1 supplies four processed data streams D1 to D4, for example, each of which carrying, in processed form, a corresponding portion of input data ID1.

Optical source OS-1 includes a laser 108, for example, a distributed feedback laser (DFB) to supply light to at least four (4) modulators 106, 112, 126 and 130. In particular, DFB 108 outputs continuous wave (CW) light to a dual output splitter or coupler 110 (e.g. a 3 db coupler) having an input port and first and second output ports. Typically, the waveguides used to connect the various components of optical source OS-1 may be polarization dependent. A first output 110a of coupler 110 supplies the CW light to first branching unit 111 and the second output 110b supplies the CW light to second branching unit 113. A first output 111a of branching unit 111 is coupled to modulator 106 and a second output 111b is coupled to modulator 112. Similarly, first output 113a is coupled to modulator 126 and second output 113b is coupled to modulator 130. Modulators 106, 112, 126 and 130 may be, for example, Mach Zender (MZ) modulators. Each of the MZ modulators receives CW light from DFB 108 and splits the light between two (2) arms or paths. An applied electric field in one or both paths of a MZ modulator creates a change in the refractive index. In one example, if the relative phase between the signals traveling through each path is 180° out of phase, destructive interference results and the signal is blocked. If the signals traveling through each path are in phase, the light may pass through the device and modulated with an associated data stream. The applied electric field may also cause changes in the refractive index such that a phase of light output from the MZ modulator is shifted or changed relative to light input to the MZ modulator. Thus, appropriate changes in the electric field can cause changes in phase of the light output from the MZ modulator.

Each of the MZ modulators 106, 112, 126 and 130 are driven with data signals or drive signals supplied via driver circuits 104, 116, 122 and 132 respectively. In particular, a first processed data stream D1 at a data rate of, for example, 10 Gbit/second, is supplied on line 140 to pre-coder circuit 102. Pre-coder circuit 102 may perform differential encoding on processed data stream D1. The encoded data is supplied to driver circuit 104 which supplies drive signals that drive MZ modulator 106. The CW light supplied to MZ modulator 106 via DFB 108 and branching unit 111 is modulated with the encoded data from driver circuit 104. The modulated data signal from MZ modulator 106 is supplied to first input 115a of branching unit 115. Similarly, a second processed data stream D2 which may also be at a data rate of, for example, 10 Gbit/second, is supplied on line 142 to pre-coder circuit 118 which also performs differential encoding. The encoded data is then supplied to driver circuit 116 which supplies further drive signals for driving MZ modulator 112. The CW light supplied to MZ modulator 112 via DFB 108 and branching unit 111 is modulated with the encoded data carried by drive signals from driver circuit 116. The modulated data signal from MZ modulator 112 is supplied to phase shifter 114 which shifts the phase of the signal 90° (π/2) to generate one of an in-phase (I) or quadrature (Q) components, which is supplied to second input 115b of branching unit 115. The modulated data signals from MZ modulator 106, which includes the other of the I and Q components, and from MZ modulator 112 are supplied to polarization beam combiner (PBC) 138 via branching unit 115.

A third processed data stream D3 is supplied on line 144 to pre-coder circuit 120, which also differentially encodes the received data. The encoded data is supplied to driver circuit 122 which, in turn, supplies drive signals for driving MZ modulator 126. MZ modulator 126, in turn, outputs modulated optical signals as one of the I and Q components. A polarization rotator 124 may optionally be disposed between coupler 110 and branching unit 113. Polarization rotator 124 may be a two port device that rotates the polarization of light propagating through the device by a particular angle, usually an odd multiple of 90°. The CW light supplied from DFB 108 is rotated by polarization rotator 124 and is supplied to MZ modulator 126 via first output 113a of branching unit 113. MZ modulator 126 then modulates the polarization rotated CW light supplied by DFB 108, in accordance with drive signals from driver circuit 122. Such drive signals are output in response to encoded data received by driver circuit 122. The modulated data signal from MZ modulator 126 is supplied to first input 117a of branching unit 117.

A fourth processed data stream 146 which may also be at a data rate of, for example, 10 Gbit/second, is supplied to pre-coder circuit 134 which differentially encodes the received data. The encoded data is supplied to driver circuit 132 which supplies drive signals for driving MZ modulator 130. The CW light supplied from DFB 108 is also rotated by polarization rotator 124 and is supplied to MZ modulator 130 via second output 113b of branching unit 113. MZ modulator 130 then modulates the received optical signal in accordance with encoded data received from driver 132. The modulated data signal from MZ modulator 130 is supplied to phase shifter 128 which shifts the phase the incoming signal 90° (π/2) and supplies the other of the I and Q components to second input 117b of branching unit 117. Alternatively, polarization rotator 136 may be disposed between branching unit 117 and PBC 138 and replaces rotator 124. In that case, the polarization rotator 136 rotates both the modulated signals from MZ modulators 126 and 130 rather than the CW signal from DFB 108 before modulation. The modulated data signal from MZ modulator 126 is supplied to first input port 138a of polarization beam combiner (PBC) 138. The modulated data signal from MZ modulator 130 is supplied to second input port 138b of polarization beam combiner (PBC) 138. PBC 138 combines all four (4) of the modulated data signals from branching units 115 and 117 and outputs a multiplexed optical signal to output port 138c. In this manner, one DFB laser 108 provides a CW signal to four (4) separate MZ modulators 106, 112, 126 and 130 for modulating at least four (4) separate data channels by utilizing phase shifting and polarization rotation of the transmission signals. Conventionally, multiple CW light sources were used for each channel which increased device complexity, chip real estate, power requirements and associated manufacturing costs.

Alternatively, splitter or coupler 110 may be omitted and DFB 108 may be configured as a dual output laser source to provide CW light to each of the MZ modulators 106, 112, 126 and 130 via branching units 111 and 113. In particular, coupler 110 may be replaced by DFB 108 configured as a back facet output device. Both outputs of DFB laser 108, from respective sides 108-1 and 108-2 of DFB 108, are used, in this example, to realize a dual output signal source. A first output 108a of DFB 108 supplies CW light to branching unit 111 connected to MZ modulators 106 and 112. The back facet or second output 108b of DFB 108 supplies CW light branching unit nit 113 connected to MZ modulators 126 and 130 via path or waveguide 143 (represented as a dashed line in FIG. 3a). The dual output configuration provides sufficient power to the respective MZ modulators at a power loss far less than that experienced through 3 dB coupler 110. The CW light supplied from second output 108b is supplied to waveguide 143 which is either coupled directly to branching unit 113 or to polarization rotator 124 disposed between DFB 108 and branching unit 113. Polarization rotator 124 rotates the polarization of CW light supplied from second output 108b of DFB 108 and supplies the rotated light to MZ modulator 126 via first output 113a of branching unit 113 and to MZ modulator 130 via second output 113b of branching unit 113. Alternatively, as noted above, polarization rotator 124 may be replaced by polarization rotator 136 disposed between branching unit 117 and PBC 138. In that case, polarization rotator 136 rotates both the modulated signals from MZ modulators 126 and 130 rather than the CW signal from back facet output 108b of DFB 108 before modulation.

The polarization multiplexed output from PBC 138, may be supplied to multiplexer 204 in FIG. 2, along with the polarization multiplexed output from remaining optical sources OS-2 to OS-m, to AWG 204, which, in turn, supplies one of optical carrier groups, OCG1, to multiplexer 14. It is understood that remaining TX PICs operation in a similar fashion and include similar structure as TX PIC-1 shown in FIG. 2.

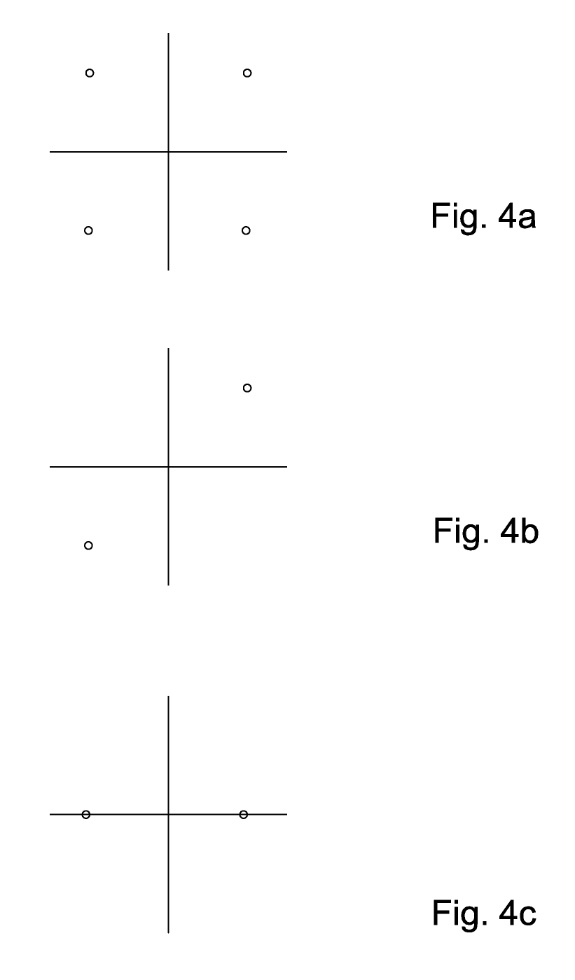

In the example shown in FIG. 3a, a first modulated optical signal having a DQPSK modulation format and a first polarization is supplied to first input 138a to polarization beach combiner (PBC) 138a and a second modulated optical signal having the DQPSK modulation format and a second polarization is supplied to a second input 138b of PBC 138. Typically, DQPSK modulated optical signals have a known constellation corresponding to that shown in FIG. 4a. Consistent with a first aspect of the present disclosure, however, further control signals are supplied by control circuit 207 such that the same processed data (DA) is output from input circuit 202-1 on lines 140 and 142, and the same processed data DB is output on lines 144 and 146. As a result, the constellation of the first and second modulated optical signals will resemble that shown in FIG. 4b. As generally understood, the constellation shown in FIG. 4b may be rotated in a known manner, for example, to correspond to that of a differential phase shift keying (DPSK) modulation format (see FIG. 4c). Although DPSK modulated optical signals, such as those supplied to inputs 138a and 138b of PBC 138, may not carry as many bits per unit of spectrum (i.e., such signals have a lower spectral efficiency), DPSK signals have lower minimum OSNR requirements (optical signal-to-noise ratio) and may be transmitted over greater distances than DQPSK modulated optical signals. Accordingly, for shorter distance optical links, control circuit 207 may be configured to supply control signals, such that optical signals having a DQPSK modulation format are output from PBC 138 in response thereto. And, for longer distances, control circuit 207 may be configured to supply control signals, such that optical signals having a DPSK modulation format are output from PBC 138 in response thereto.

Alternatively, consistent with a further aspect of the present disclosure and in response to additional control signals from control circuit 207, processed duplicate data streams DB may be omitted so that no modulated optical signals having the second polarization are supplied to PBC 138. In addition, modulators 126 and 130 may be deactivated, so that a DPSK modulated optical signal having one polarization may be output from PBC 138.

Consistent with a further aspect of the present disclosure, pre-coder circuits 102, 118, 120, and 134 may be configured to encode the processed data D1, D2, D3, and D4 (in FIG. 3a above) consistent with modulation formats other than those discussed above. For example, if receiver node 18 is configured for coherent detection, phase-based encoding (as opposed to differential encoding discussed above) may be employed in pre-coder circuits 102, 118, 120, and 134 so that driver circuits 104, 116, 122, and 132, respectively, output drive signals to drive modulators 106, 112, 126, and 130 to supply optical signals modulated in accordance with a quadrature phase shift keying (QPSK) modulation format. Such optical signals have a constellation similar to that shown in FIG. 3a, but are not differentially encoded. That is, as generally understood, the phase of these optical signals is indicative of the data carried thereby. On the other hand, in the differential encoding scheme discussed above, the change in phase of the optical signals indicates the data carried thereby.

Thus, in response to control signals output from control circuit 207, data signals D1 to D4 may be supplied to precoder circuits 102, 118, 120, and 134, such that first and second QPSK modulated optical signals, having first and second polarizations, respectively, are supplied to PBC 138. Alternatively, in a manner similar to that noted above in connection with FIG. 3b, in response to further control signals output from control circuit 207, the same data may be supplied to pre-coder circuits 102 and 118, and the same data may be supplied to pre-coder circuits 120 and 134. As a result, optical signals input to PBC 138 will have a constellation similar to that shown in FIG. 4b, which, when rotated in FIG. 4c, may correspond to that of a binary phase shift keying (BPSK) format.

Optionally, in response to additional control signals output from control circuit 207, the same data may be supplied on lines 140 and 142, while no data is output on lines 144 and 146. In that case, as in FIG. 3c, light having one polarization may be output from PBC 138, and such light, in the present example, may have a BPSK modulation format.

BPSK signals, like the DPSK signals discussed above, have lower spectral efficiency, but a higher OSNR than QPSK modulated signals. Accordingly, BPSK signals are better suited for longer distance links, and QPSK signals may be transmitted over shorter ones. In the examples discussed above, by appropriate application of the control signals output from control circuit 207, the same PICs and input circuits may be used to supply optical signals having different modulation formats. Thus, consistent with the present disclosure, instead of manufacturing different transmitters for different optical fiber links, such that each transmitter is tailored for a particular optical fiber link, for example, the same transmitter may be controlled to output optical signals having different modulation formats, and, therefore, may be used for a variety of optical fiber links.

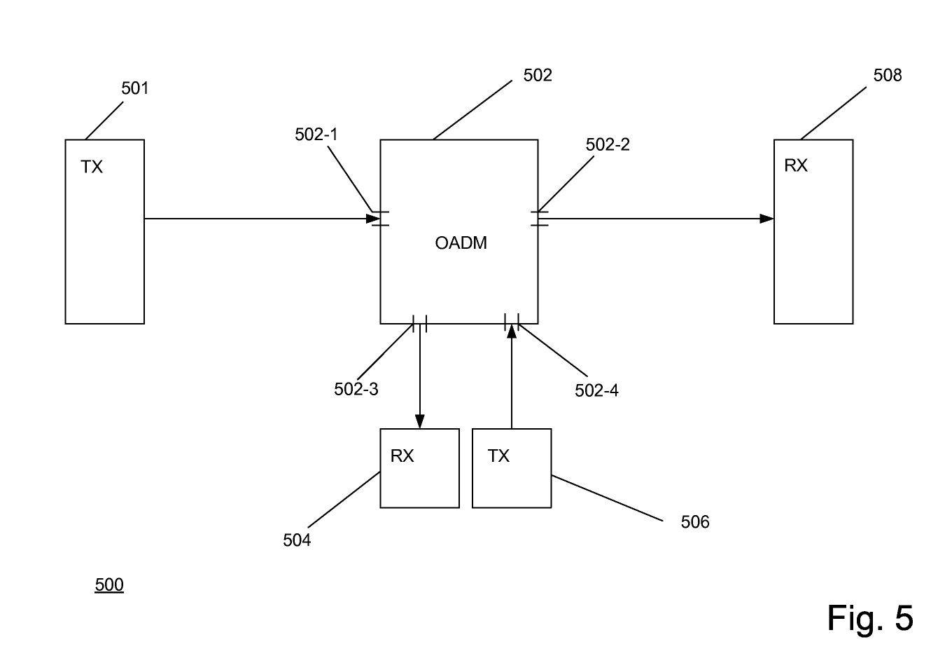

FIG. 5. illustrates an optical system 500 consistent with an additional aspect of the present disclosure. Optical system 500 includes a transmit node 501 which supplies a wavelength division multiplexed (WDM) optical signal to an input of an optical add/drop multiplexer (OADM) 502. OADM 502 has an input portion 502-1 that receives the WDM optical signal, and supplies or drops some of the optical signals or channels in the WDM optical signal through output port 502-2. Remaining optical signals in the WDM optical signal are passed or transmitted through OADM 502 and output at port 502-4. A receiver 504 is provided to detect and process the optical signals output from port 502-2. In addition, a transmitter 506 is provided that supplies optical signals, which typically have the same wavelengths as those that were dropped at port 502-2. The optical signals output from transmitter 506 are fed to port 502-3 of OADM 502, and combined with the passed-through optical signals and output at port 502-4. The resulting WDM optical signal output from OADM 502 is supplied to a receiver node 508.

In the example shown in FIG. 5, selected photonic integrated circuits (PICs) similar to those discussed above may be provided in transmit node 501 and configured to supply optical signals, which have a modulation format suitable for transmission over shorter distances. Such optical signals may then be dropped and added by OADM 502. In addition, other PICs may be provided in transmit node 501 and configured, as further discussed above, to supply optical signals having a modulation format suitable for longer distance transmission. Such optical signals may be passed through OADM 502 to receiver node 508. Alternatively, various optical sources (OS) within each PIC may be configured to supply optical signals having different modulation formats. Accordingly, for example, optical source Os-1 may be controlled to output optical signals having a BPSK format, while optical source OS-m may be configured to output optical signals having a QPSK format. Further, in accordance with another example, optical source Os-1 may be controlled to output optical signals having a DQPSK, and optical source OS-m may be configured to output optical signals having a DPSK format.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A transmitter, comprising:
a control circuit configured to selectively supply one of first control signals and second control signals;
a substrate; and
a plurality of modulators provided on the substrate, each of the plurality of modulators being coupled to the driver circuit, and each of the plurality of modulators being configured to supply a corresponding one of a plurality of modulated optical signals, such that, in response to the first control signals, the modulated optical signals have a first modulation format, and, in response to the second control signals, the modulated optical signals have a second modulation format different than the first modulation format.

2. A transmitter in accordance with claim 1, further including an arrayed waveguide grating provided on the substrate, the arrayed waveguide grating including an output waveguide, the arrayed waveguide grating being configured to receive the plurality of modulated optical signals, and output a wavelength division multiplexed optical signal including the plurality of modulated optical signals at the output waveguide.

3. A transmitter in accordance with claim 1, wherein each of the plurality of modulated optical signals includes a corresponding one of a plurality of wavelengths.

4. A transmitter in accordance with claim 1, wherein the first modulation format is a differential quadrature phase shift keying (DQPSK) modulation format, and the second modulation format is a differential phase shift keying (DPSK) format.

5. A transmitter in accordance with claim 1, wherein the first modulation format is a quadrature phase shift keying (QPSK) format and the second modulation format is a binary phase shift keying (BPSK) format.

6. A transmitter in accordance with claim 1, wherein the first modulation format includes one of an in-phase and quadrature component and not the other of the in-phase and quadrature component.

7. A transmitter in accordance with claim 1, further including a plurality of lasers, each of the plurality of lasers having a corresponding one of a plurality of first sides, each of which supplying a corresponding one of a first plurality of optical signals, each of the plurality of lasers having a corresponding one of a plurality of second sides, each of which supplying a corresponding one of a second plurality of optical signals, each of the first plurality of optical signals being supplied to a corresponding one of a first group of the plurality of modulators and each of the second plurality of optical signals being supplied to a corresponding one of a second group of the plurality of modulators.

8. A transmitter in accordance with claim 7, wherein the plurality of lasers are provided on the substrate.

9. A transmitter in accordance with claim 1, further including:
a plurality of lasers, each of the plurality of lasers supplying a corresponding one of a plurality of optical signals;
a plurality of splitters, each of which receiving a corresponding one of the plurality of optical signals and outputting a corresponding one of first optical signal portion and a corresponding one of second optical signal portions, each of the first optical signal portions being supplied to a corresponding one of a first group of the plurality of modulators and each of the second optical signal portions being supplied to a corresponding one of a second group of the plurality of modulators.

10. A transmitter in accordance with claim 9, wherein the plurality of lasers are provided on the substrate.

11. A transmitter in accordance with claim 8, wherein each of the plurality of lasers includes a distributed feedback (DFB) laser.

12. A transmitter in accordance with claim 12, wherein each of the plurality of lasers includes a distributed feedback (DFB) laser.

13. A transmitter in accordance with claim 1, wherein each of the plurality of modulators includes a Mach-Zehnder modulator.

14. A transmitter in accordance with claim 13, wherein each of the plurality of modulators includes a nested Mach-Zehnder modulator.

15. A transmitter in accordance with claim 1, wherein each of the plurality of modulators includes an electro-absorption modulator.

16. A transmitter, comprising:
a control circuit coupled to the driver circuit, the control circuit being configured to selectively supply first, second, third, and fourth control signals;
a driver circuit configured to output a first, second, third, and fourth pluralities of drive signals in response to the first, second, third, and fourth control signals, respectively;
a substrate;
a plurality of optical outputs provided on the substrate, such that, first ones of the plurality of optical outputs supply first light having a first polarization in response to the first plurality of drive signals, and second ones of the plurality of optical outputs are deactivated in response to the second plurality of drive signals, the first ones of the plurality of optical outputs are deactivated in response to the third plurality of drive signals, the second ones of the plurality of optical outputs supply second light having a second polarization in response to the fourth plurality of drive signals.

17. A transmitter in accordance with claim 16, wherein, the control circuit is further configured to selectively supply fifth signals to the driver circuit, the driver circuit being configured to supply fifth and sixth pluralities of drive signals in response to the first plurality of control signals, such that first ones of the plurality of optical outputs supply the first light having the first polarization in response to fifth plurality of drive signals and the second ones of the plurality of optical outputs supply the second light having the second polarization in response to the sixth plurality of drive signals.

18. A transmitter in accordance with claim 17, further including a polarization beam combiner having an output, the polarization beam combiner being configured to receive the light having the first polarization and the light having the second polarization, and supply the first and second lights at the output of the polarization beam combiner.

19. An optical communication system, comprising:
a transmitter configured to supply first optical signals, which have been modulated in accordance with a first modulation format, the transmitter further being configured to supply second optical signals which have been modulated in accordance with a second modulation format;
a first receiver configured to receive the first optical signal, the first receiver including a first circuit configured to process the first optical signal and extract first data carried by the first optical signal; and
a second receiver configured to receive the second optical signal, the first receiver including a second circuit configured to process the second optical signal and extract second data carried by the second optical signal.

20. An optical communication system in accordance with claim 19, wherein the first modulation format is a differential quadrature phase shift keying (DQPSK) modulation format, and the second modulation format is a differential phase shift keying (DPSK) format.

21. A transmitter in accordance with claim 19, wherein the first modulation format is a quadrature phase shift keying (QPSK) format and the second modulation format is a binary phase shift keying (BPSK) format.

22. A transmitter in accordance with claim 19, wherein the first modulation format includes one of an in-phase and quadrature component and not the other of the in-phase and quadrature component.

23. An optical communication system, comprising:
a transmitter configured to supply a first optical signal, which has been modulated in accordance with a first modulation format, the transmitter further being configured to supply a second optical signal which has been modulated in accordance with a second modulation format, the first optical signal having a first wavelength and the second optical signal having a second wavelength;
an add/drop multiplexer, the add/drop multiplexer having a first port configured to receive the first and second optical signals, a second port supplying the first optical, a third port configured to receive a third optical signal having the first wavelength, and a fourth port configured to supply the second optical signal and the third optical signal;
a first receiver configured to receive the first optical signal from the second port of the add/drop multiplexer, the first receiver including a first circuit configured to process the first optical signal and extract first data carried by the first optical signal; and
a second receiver configured to receive the second optical signal from the fourth port of the add/drop multiplexer, the second receiver including a second circuit configured to process the second optical signal and extract second data carried by the second optical signal.

24. An optical communication system in accordance with claim 24, wherein the first modulation format is a differential quadrature phase shift keying (DQPSK) modulation format, and the second modulation format is a differential phase shift keying (DPSK) format.

25. A transmitter in accordance with claim 24, wherein the first modulation format is a quadrature phase shift keying (QPSK) format and the second modulation format is a binary phase shift keying (BPSK) format.

26. A transmitter in accordance with claim 24, wherein the first modulation format includes one of an in-phase and quadrature component and not the other of the in-phase and quadrature component.
